(19) United States
(12) Patent Application Publication
(10) Pub. No.: US 2010/0026646 A1
(43) Pub. Date: Feb. 4, 2010

(54) OVERLAY FILM AND ELECTRONIC DEVICE WITH SAME

(75) Inventors: SHI-XIN XIAO, Shenzhen City (CN); CHUNG-YUAN CHEN, Tu-Cheng (TW); LONG-FONG CHEN, Tu-Cheng (TW); JI-PING WU, Shenzhen City (CN); SHI-BIN LI, Shenzhen City (CN); YI-TAO HUA, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION UNDUSTRY CO., LTD., Tu Chen (TW)

(21) Appl. No.: 12/503,017

(22) Filed: Jul. 14, 2009

(30) Foreign Application Priority Data
Aug. 1, 2008 (CN) 200810303315.8

(51) Int. Cl. G06F 3/041

(52) U.S. Cl. 345/173

(57) ABSTRACT

An overlay film for covering a touch screen of an electronic device is disclosed. The touch screen is configured for showing a number of icons thereon for receiving user inputs. The overlay film is a thin, transparent layer. The overlay film defines a plurality of through holes corresponding to the shapes and positions of the icons on the touch screen.

### BACKGROUND

1. Technical Field

The present disclosure relates to touch screens, and particularly to an overlay film for covering a touch screen.

2. Description of Related Art

Currently, touch screens are widely used in electronic devices. The touch screens can display virtual keypads to receive control commands. However, the operating surface of the touch screens is typically smooth. Thus, operating the virtual keypads requires focus and attention to avoid actuating a wrong virtual input key. This is an inconvenience.

What is needed, therefore, is an overlay film and an electronic device with the same to overcome the above-mentioned problems.

### BRIEF DESCRIPTION OF THE DRAWINGS

FIG. 1 is a schematic view of an electronic device with an overlay film, according to an exemplary embodiment of the present disclosure.

FIG. 2 is a plane, schematic view the overlay film of the electronic device of FIG. 1.

FIG. 3 is a plane, schematic view of the electronic device of FIG.1, of which the touch screen displays a virtual keypad.

FIG. 4 is an overlay film for the electronic device of FIG. 3.

### DETAILED DESCRIPTION

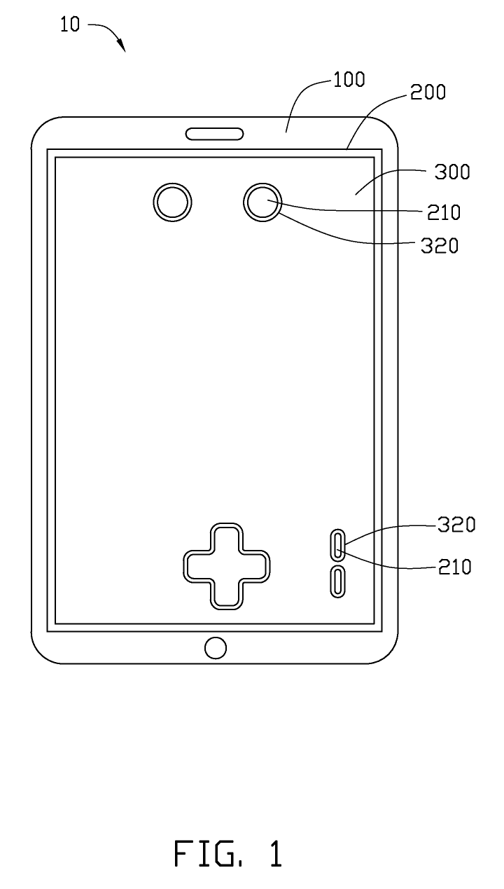

Referring to FIG. 1, an electronic device 10, according to an exemplary embodiment, is shown. The electronic device 10 includes a main body 100, a touch screen 200, and an overlay film 300. The touch screen 200 is framed in the main body 100. The overlay film 300 is pasted over the touch screen 200.

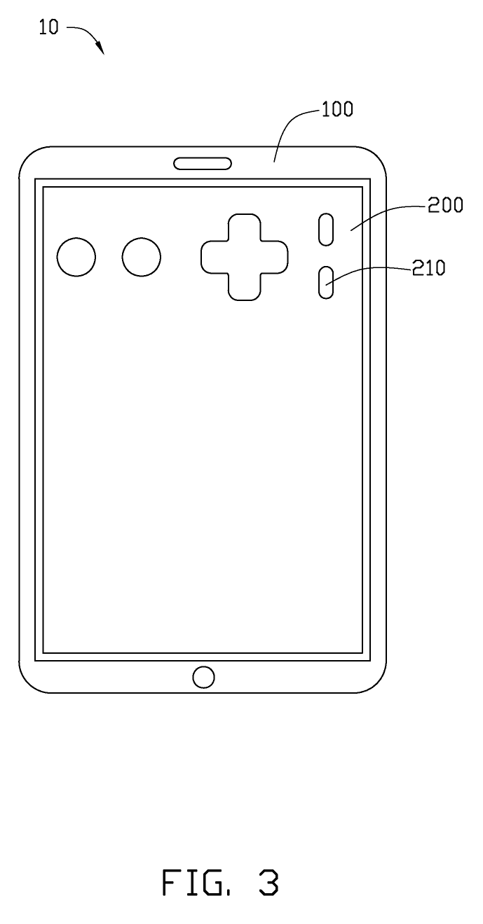

The touch screen 200 is configured for showing a number of icons 210 thereon. The icons 210 can be virtual keys (see FIG. 3) or a representation of a file or a folder. Therefore, users can trigger a control command by performing operations on the virtual keys or access the file or the folder by clicking the corresponding representation. In this embodiment, the icons 210 consist of virtual buttons of a virtual game pad/joy pad for controlling a video game on the electronic device 10. The touch screen 200 can be a resistive touch screen, a capacitive touch screen, or a surface acoustic wave touch screen, and so on.

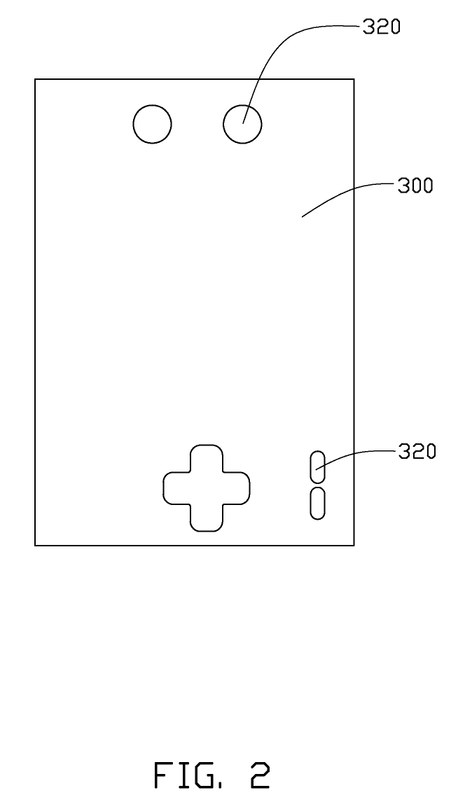

Referring also to FIG. 2, the overlay film 300 is a thin layer made from transparent material. Advantageously, the film 300 defines a number of through holes 320 corresponding to the icons 210 shown on the touch screen 200. The shape and size of each through holes 320 also correspond to the icons 210. In this embodiment, a surface of the overlay film 300 is pasted on the touch screen via adhesive. In other embodiments, a surface of the overlay film 300 may be self-adhesive and can be stuck on the touch screen 200 by itself.

With the overlay film 300 defining the through holes 320 corresponding to the icons 210, the virtual buttons can be felt via the through holes 320. Therefore, locating and actuating the virtual buttons of a game is more accurate. As such, misoperations can be avoided.

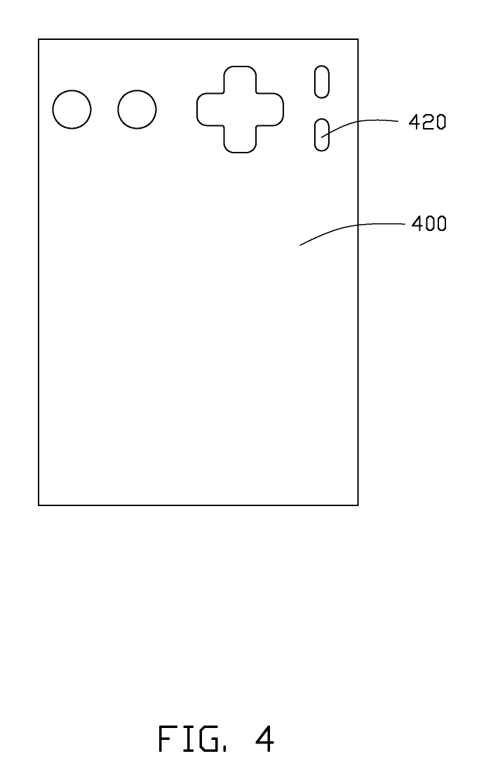

Of course, the icons 210 may be shown with different shapes and different positions on the touch screen 200 corresponding to different software of the electronic device 10. And, the shapes and positions of the through holes in the overlay film 300 can be changed correspondingly to the icons 210 shown on the touch screen 200. Referring to FIGS. 3-4, the icons 210 are shown on the touch screen 200 of the electronic device 10 with different positions from that of FIG. 1, so that the through holes 420 are defined in the overlay film 400 with different positions from that of FIG. 2.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An overlay film for covering a touch screen of an electronic device, the touch screen being configured for showing a plurality of icons thereon for receiving user inputs, the overlay film being a thin, transparent layer and defining a plurality of through holes corresponding to the shapes and positions of the icons.

2. The overlay film of claim 1, wherein the overlay film is pasted on the touch screen via adhesive.

3. The overlay film of claim 1, wherein a surface of the overlay film is self-adhesive, and the overlay film is stuck on the touch screen by itself.

4. An electronic device, comprising:
a main body:
a touch screen framed by the main body and configured for showing a plurality of icons thereon for receiving user inputs: and
an overlay film stuck on the touch screen, the overlay film being a thin, transparent layer and defining a plurality of through holes corresponding to the shapes and positions of the icons on the touch screen.

5. The electronic device of claim 4, wherein the touch screen is selected from the group consisting of a resistive touch screen, a capacitive touch screen, and a surface acoustic wave touch screen.

6. The electronic device of claim 4, wherein the icons are a plurality of virtual controlling keys of a video game.

7. The electronic device of claim 4, wherein the overlay film is pasted on the touch screen via adhesive.

8. The electronic device of claim 4, wherein a surface of the overlay film is self-adhesive, and the overlay film is stuck on the touch screen by itself.
